(19) United States
(12) Patent Application Publication
(10) Pub. No.: US 2024/0337114 A1
(43) Pub. Date: Oct. 10, 2024

(54) Textured Sheetrock Mud Applicator Device

(71) Applicant: Derek Nanouk, Kotzebue, AK (US)

(72) Inventor: Derek Nanouk, Kotzebue, AK (US)

(21) Appl. No.: 18/359,279

(22) Filed: Jul. 26, 2023

Related U.S. Application Data
(60) Provisional application No. 63/494,552, filed on Apr. 6, 2023.

(51) Int. Cl. E04F 21/10

(52) U.S. Cl. CPC E04F 21/10

(57) ABSTRACT

A textured sheetrock mud applicator device is provided. The device is comprised of a textured sheetrock mud applicator device that allows a user to easily apply textured mud to sheetrock without the need for an air compressor and other specialized equipment. The device is comprised of at least one hopper that stores sheetrock mud and is in fluid communication with at least one body such that the hopper supplies mud to the body. The mud is then dispensed from the body in a textured form from an opening of the body as a result of a spinning brush within the body. The spinning brush is comprised of an attachment member that can be received by a chuck of a drill to spin the brush during use.

### CROSS-REFERENCE TO RELATED APPLICATION

The present application claims priority to, and the benefit of, U.S. Provisional Application No. 63/494,552, which was filed on Apr. 6, 2023, and is incorporated herein by reference in its entirety.

### FIELD OF THE INVENTION

The present invention relates generally to the field of sheetrock mud. More specifically, the present invention relates to a textured sheetrock mud applicator device that can be attached to a drill and allows a user to easily apply textured mud to a sheetrock surface without the need for an air compressor or other specialized equipment. Accordingly, the present disclosure makes specific reference thereto. Nonetheless, it is to be appreciated that aspects of the present invention are also equally applicable to other like applications, devices, and methods of manufacture.

### BACKGROUND

Applying textured sheetrock is a complex and time-consuming endeavor, demanding a combination of specialized equipment and materials. To achieve the desired texture, several essential tools are typically required, including an air compressor, air hoses, a hopper gun, and texture spray cans. Each of these components plays a crucial role in the application process, making it challenging for individuals without access to them to effectively spray textured mud.

However, not all individuals have access to or can afford the extensive range of equipment needed for this process. In certain situations, individuals may find themselves lacking the means to utilize all these items on a worksite, leaving them with no viable way to spray textured mud. This can pose a significant challenge, especially for DIY enthusiasts or small-scale renovation projects where investing in such equipment may not be feasible.

Therefore, there exists a long-felt need in the art for a device that can be used to apply textured mud to sheetrock. There also exists a long-felt need in the art for a textured sheetrock mud applicator device that allows a user to easily apply textured mud to sheetrock. More specifically, there exists a long-felt need in the art for a textured sheetrock mud applicator device that allows a user to easily apply textured mud to sheetrock without the need for an air compressor. air hoses, a hopper gun, and texture spray cans.

The subject matter disclosed and claimed herein, in one embodiment thereof, comprises a textured sheetrock mud applicator device. The device is comprised of a textured sheetrock mud applicator device that allows a user to easily apply textured mud to sheetrock without the need for an air compressor and other specialized equipment. The device is comprised of at least one hopper that stores sheetrock mud and is in fluid communication with at least one body such that the hopper supplies mud to the body. The mud is then dispensed from the body in a textured form from an opening of the body as a result of a spinning brush within the body. The spinning brush is comprised of an attachment member that can be received by a chuck of a drill to spin the brush during use.

In this manner, the textured sheetrock mud applicator device of the present invention accomplishes all the foregoing objectives and provides a device that can be used to apply textured mud to sheetrock. Furthermore, the device allows a user to easily apply textured mud to sheetrock without the need for an air compressor, air hoses, a hopper gun, texture spray cans, and other specialized equipment. In addition, the device can be used with any drill known in the art in a universal manner.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a textured sheetrock mud applicator device that allows a user to easily apply textured mud to sheetrock without the need for an air compressor and other specialized equipment. The device is comprised of at least one hopper that stores sheetrock mud and is in fluid communication with at least one body such that the hopper supplies mud to the body. The mud is then dispensed from the body in a textured form from an opening of the body as a result of a spinning brush within the body.

During use, sheetrock mud (or any other compound of the like) is stored within an interior space of at least one hopper of the device. A second end of the hopper allows mud to flow from the hopper into the body of the device. In one embodiment, the amount of mud entering the body from the hopper can be adjusted by at least one valve or other similar mechanism on the hopper. The body is also comprised of at least one opening that allows mud to exit the body during use.

More specifically, at least one texture brush is positioned within the body. The brush is comprised of at least one male drill attachment member which exits the body and can be received by the chuck of a drill. As a result, rotation of the drill/chuck rotates the brush within the body to dispense mud from the opening in a textured manner.

The present invention is also comprised of a method of using the device. First, a device is provided comprised of at least one hopper that attaches to a body, wherein the body is comprised of a first opening, a second opening, and a texture brush comprised of a drill attachment. Then, a male member of the hopper is attached to a female member of the body, wherein sheetrock mud can then be poured into the hopper. Next, the drill attachment can be attached to a chuck of a drill and at least one valve of the hopper can be opened to allow the sheetrock mud to flow into the body as the drill is spun such that the brush rotates within the body. As a result, sheetrock mud can be dispensed from the body via the opening, wherein the brush gives the mud a textured finish as the mud is applied to a sheetrock surface from the opening.

Accordingly, the textured sheetrock mud applicator device of the present invention is particularly advantageous as it provides a device that can be used to apply textured mud to sheetrock. More specifically, the device allows a user to easily apply textured mud to sheetrock without the need for an air compressor, air hoses, a hopper gun, and texture spray cans. In this manner, the textured sheetrock mud applicator device overcomes the limitations of existing methods and devices used to apply textured mud to sheetrock that is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a textured sheetrock mud applicator device of the present invention in accordance with the disclosed architecture;

FIG. 2 illustrates an enhanced perspective view of a first end of a hopper of one potential embodiment of a textured sheetrock mud applicator device of the present invention in accordance with the disclosed architecture;

FIG. 3 illustrates an enhanced perspective view of a second end of a hopper of one potential embodiment of a textured sheetrock mud applicator device of the present invention in accordance with the disclosed architecture;

FIG. 4 illustrates an exploded view of a body of one potential embodiment of a textured sheetrock mud applicator device of the present invention in accordance with the disclosed architecture;

FIG. 5 illustrates a perspective view of one potential embodiment of a textured sheetrock mud applicator device of the present invention while attached to a drill in accordance with the disclosed architecture; and

FIG. 6 illustrates a flowchart of a method of using one potential embodiment of a textured sheetrock mud applicator device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not show all the aspects or advantages. Thus, in other embodiments, any of the features described herein from different embodiments may be combined.

As noted above, there exists a long-felt need in the art for a device that can be used to apply textured mud to sheetrock. There also exists a long-felt need in the art for a textured sheetrock mud applicator device that allows a user to easily apply textured mud to sheetrock. More specifically, there exists a long-felt need in the art for a textured sheetrock mud applicator device that allows a user to easily apply textured mud to sheetrock without the need for an air compressor, air hoses, a hopper gun, and texture spray cans.

The present invention, in one exemplary embodiment, is comprised of a textured sheetrock mud applicator device. The device allows a user to easily apply textured mud to sheetrock without the need for an air compressor and other specialized equipment. The device is comprised of at least one hopper that stores sheetrock mud. The hopper is in fluid communication with at least one body such that the hopper supplies mud to the body. The mud is then dispensed from the body in a textured form from an opening of the body as a result of a spinning brush within the body.

During use, sheetrock mud (or any other compound of the like) is stored within an interior space of at least one hopper of the device. A second end of the hopper allows mud to flow from the hopper into the body of the device, wherein the amount of mud entering the body from the hopper can be adjusted by at least one valve or another similar mechanism on the hopper in one embodiment. The body is also comprised of at least one opening that allows mud to exit the body during use.

More specifically, at least one texture brush is positioned within the body. The brush is comprised of at least one male drill attachment member which exits the body and can be received by the chuck of a drill. Rotation of the drill/chuck then rotates the brush within the body to dispense mud from the opening in a textured manner.

The present invention is also comprised of a method of using the device. First, a device is provided comprised of at least one hopper that attaches to a body, wherein the body is comprised of a first opening, a second opening, and a texture brush comprised of a drill attachment. Then, a male member of the hopper is attached to a female member of the body, wherein sheetrock mud can then be poured into the hopper. Next, the drill attachment can be attached to a chuck of a drill and at least one valve of the hopper can be opened to allow the sheetrock mud to flow into the body as the drill is spun such that the brush rotates within the body. As a result, sheetrock mud can be dispensed from the body via the opening, wherein the brush gives the mud a textured finish as the mud is applied to a sheetrock surface from the opening.

Accordingly, the textured sheetrock mud applicator device of the present invention is particularly advantageous as it provides a device that can be used to apply textured mud to sheetrock. More specifically, the device allows a user to easily apply textured mud to sheetrock without the need for an air compressor, air hoses, a hopper gun, and texture spray cans. In this manner, the textured sheetrock mud applicator device overcomes the limitations of existing methods and devices used to apply textured mud to sheetrock that is known in the art.

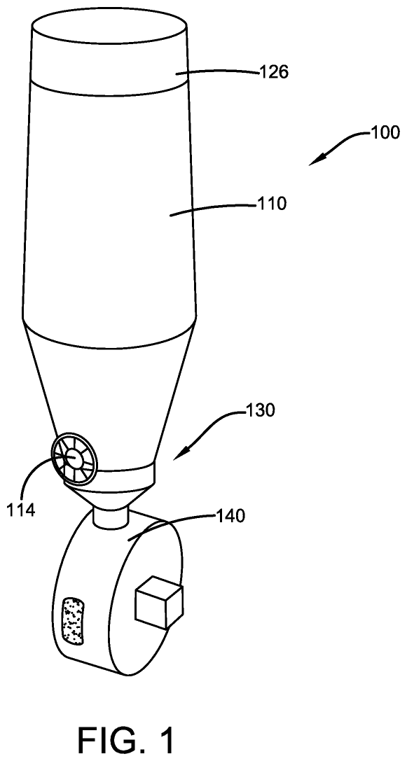

Referring initially to the drawings, FIG. 1 illustrates a perspective view of one potential embodiment of a textured sheetrock mud applicator device 100 of the present invention in accordance with the disclosed architecture. The device 100 allows a user to easily apply textured mud 20 to sheetrock without the need for an air compressor and other specialized equipment. The device 100 is comprised of at least one hopper 110 that stores sheetrock mud 20. The hopper 110 is in fluid communication with at least one body 140. In this manner, the hopper 110 supplies mud 20 to the body 140. The mud 20 is then dispensed from the body 140 in a textured form from an opening 160 of the body 140 as a result of a spinning brush 170 within the body 140.

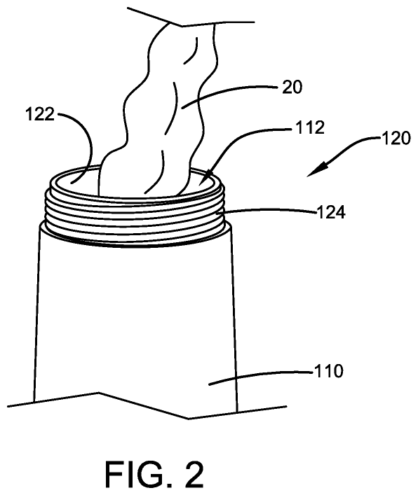

During use, sheetrock mud 20 (or any other compound of the like) is stored within an interior space 112 of at least one hopper 110 of the device 100, as seen in FIG. 2. The hopper 110 is generally cylindrical but may be any shape in different embodiments. The hopper 110 is comprised of a first end 120 with a first opening 122. The opening 122 allows sheetrock mud 20 to be poured into the interior space 112 of the hopper 110. The opening 122 is comprised of at least one fastener 124. The fastener 124 receives at least one cap 126 that closes the opening 122 after mud 20 has been poured into the interior space 112. In the preferred embodiment, the fastener 124 is comprised of a male thread, and the cap 126 is comprised of a female-threaded cap. However, the fastener 124 and cap 126 may be any type of reciprocating fasteners known in the art.

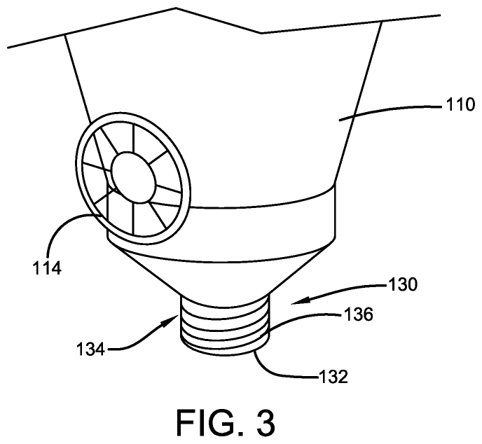

The second end 130 of the hopper 110 allows mud 20 to flow from the hopper 110 into the body 140 of the device 100. More specifically, the second end 130 is comprised of at least one opening 132 in fluid communication with at least one opening 145 of a female member 144 of the body 140. The opening 132 of the second end 130 is preferably comprised of at least one male member 134 with at least one fastener 136 which engages at least one fastener 146 of the female member 144, as seen in FIG. 3. The fasteners 136,144 may be any type of reciprocating fasteners known in the art but are preferably male and female threads.

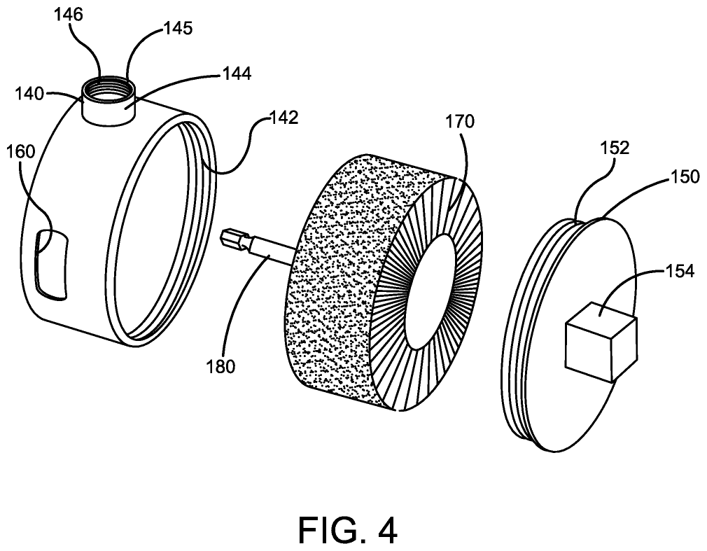

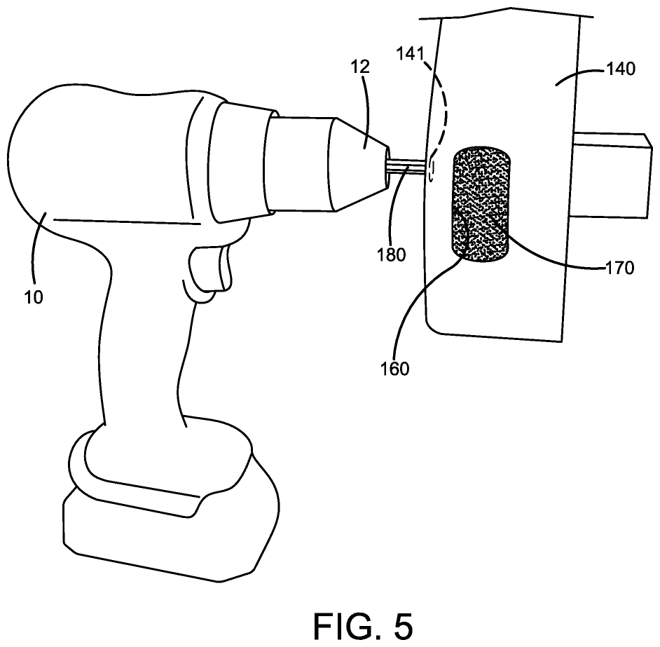

The body 140 is also comprised of at least one opening 160 that allows mud 20 to exit the body 140 during use, as seen in FIG. 4. More specifically, at least one texture brush 170 is positioned within the body 140. The brush 170 may be of any style, material, and configuration to produce a desired mud 20 texture. The brush 170 is comprised of at least one male drill attachment member 180 which exits the body 140 via at least one opening 141 and can be received by the chuck 12 of a drill 10, as seen in FIG. 5. The member 180 may be any type of drill shank known in the art. As a result, the rotation of the drill 10/chuck 12 rotates the brush 170 within the body 140 to dispense mud 20 from the opening 160 in a textured manner.

In one embodiment, the amount of mud 20 entering the body 140 from the hopper 110 can be adjusted by at least one valve 114 or another similar mechanism on the hopper 110. The valve 114 can be used to increase/decrease the flow of mud 20 from the hopper 110 to the body 140. As a result, the user can control how much mud 20 is dispensed from the body 140.

The body 140 can be disassembled for cleaning of the body 140 and/or brush 170. To do so, at least one cap 150 removably attaches to the body 140. More specifically, the cap 150 is comprised of at least one fastener 152 that attaches to at least one fastener 142 of the body 140. The fasteners 142,152 may be any type of reciprocating fasteners known in the art but are preferably male and female threads. In one embodiment, the cap 150 may be comprised of at least one handle 154 or grip that allows the cap 150 to be easily tightened and loosened from the body 140.

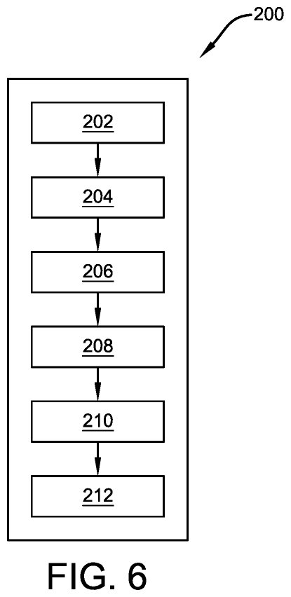

The present invention is also comprised of a method of using 200 the device 100, as seen in FIG. 6. First, a device 100 is provided comprised of at least one hopper 110 that attaches to a body 140, wherein the body 140 is comprised of a first opening 160, a second opening 141, and a texture brush 170 comprised of a drill attachment 180 [Step 202]. Then, a male member 134 of the hopper 110 is attached to a female member 144 of the body 140 [Step 204]. Next, a cap 126 is removed from the hopper 110 such that sheetrock mud 20 can be poured into the hopper [Step

. Then, the cap 126 can be replaced and secured onto the hopper 110 [Step 208]. Next, the drill attachment 180 can be attached to a chuck 12 of a drill 10 [Step 210]. Then, at least one valve 114 of the hopper 110 can be opened to allow the sheetrock mud 20 to flow into the body 140 as the drill 10 is spun such that the brush 170 rotates within the body 110 [Step 212]. As a result, sheetrock mud 20 can be dispensed from the body 140 via the opening 160, wherein the brush 170 gives the mud 20 a textured finish as the mud 20 is applied to a sheetrock surface from the opening 160.

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “textured sheetrock mud applicator device” and “device” are interchangeable and refer to the textured sheetrock mud applicator device 100 of the present invention.

Notwithstanding the foregoing, the textured sheetrock mud applicator device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the textured sheetrock mud applicator device 100 as shown in the FIGS. are for illustrative purposes only, and that many other sizes and shapes of the textured sheetrock mud applicator device 100 are well within the scope of the present disclosure. Although the dimensions of the textured sheetrock mud applicator device 100 are important design parameters for user convenience, the textured sheetrock mud applicator device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A textured sheetrock mud applicator device comprising:
a hopper comprised of a first hopper opening and a second hopper opening;
a body comprised of a first body opening, a second body opening, and a third body opening; and
a brush comprised of a shank, the brush positioned within the body.

2. A textured sheetrock mud applicator device of claim 1, wherein the shank is positioned within the first body opening.

3. A textured sheetrock mud applicator device of claim 1, wherein the hopper is in fluid communication with the body.

4. A textured sheetrock mud applicator device of claim 1, wherein the second hopper opening attaches to the second body opening via a pair of reciprocating fasteners.

5. A textured sheetrock mud applicator device of claim 4, wherein the pair of reciprocating fasteners are comprised of a pair of male and female threads.

6. A textured sheetrock mud applicator device of claim 1, wherein the brush is comprised of a texture brush.

7. A textured sheetrock mud applicator device of claim 1, wherein the hopper is comprised of a cap.

8. A textured sheetrock mud applicator device comprising:
a hopper comprised of a first hopper opening, a second hopper opening, a cap, and a valve;
a body comprised of a first body opening, a second body opening, a third body opening, and a cap; and
a brush comprised of a shank, the brush positioned within the body.

9. A textured sheetrock mud applicator device of claim 8, wherein the shank is positioned within the first body opening.

10. A textured sheetrock mud applicator device of claim 8, wherein the hopper is comprised of a hopper interior space.

11. A textured sheetrock mud applicator device of claim 10, wherein the hopper interior space is in fluid communication with a body interior space of the body.

12. A textured sheetrock mud applicator device of claim 8, wherein the second hopper opening attaches to the second body opening via a pair of reciprocating fasteners.

13. A textured sheetrock mud applicator device of claim 12, wherein the pair of reciprocating fasteners are comprised of a pair of male and female threads.

14. A textured sheetrock mud applicator device of claim 8, wherein a first cap fastener of the cap attaches to a first body fastener of the body.

15. A textured sheetrock mud applicator device of claim 14, wherein the first cap fastener and the first body fastener are comprised of a pair of male and female threads.

16. A textured sheetrock mud applicator device of claim 8, wherein the first hopper opening is comprised of a first hopper fastener.

17. A textured sheetrock mud applicator device of claim 16, wherein the first hopper fastener attaches to a hopper cap.

18. A textured sheetrock mud applicator device of claim 17, wherein the hopper cap is comprised of a threaded cap.

19. A method of using a textured sheetrock mud applicator device, the method comprising the following steps:
providing a textured sheetrock mud applicator device comprised of a hopper that attaches to a body, wherein the body is comprised of a first opening, a second opening, and a texture brush comprised of a drill attachment;
attaching a male member of the hopper to a female member of the body;
removing a cap from the hopper and pouring sheetrock mud into the hopper;
replacing and securing the cap back onto the hopper;
attaching the drill attachment to a chuck of a drill; and
opening a valve of the hopper to allow the sheetrock mud to flow into the body while spinning the drill.

20. A method of using a textured sheetrock mud applicator device of claim 19, wherein the hopper is in fluid communication with the body.
